(19) United States
(12) Patent Application Publication
(10) Pub. No.: US 2015/0336224 A1
(43) Pub. Date: Nov. 26, 2015

(54) ANTI-SEPARATING MECHANISM

(71) Applicant: Basso Industry Corp., Taichung (TW)

(72) Inventors: An-Gi LIU, Taichung (TW); Fu-Yi HUANG, Taichung (TW)

(73) Assignee: Basso Industry Corp., Taichung (TW)

(21) Appl. No.: 14/287,069

(22) Filed: May 26, 2014

(51) Int. Cl. B23P 19/00; B25B 23/04; B25C 1/00

(52) U.S. Cl. CPC B23P 19/001; B25C 1/003; B25B 23/04

(57) ABSTRACT

An anti-separating mechanism for preventing a fastener strip from separating from a fastener gun is disclosed. The anti-separating mechanism is disposed in the fastener gun. The fastener gun includes a gun body, a fastener magazine and a feed member. The gun body includes a firing channel to receive a fastener. The fastener magazine is connected to the firing channel and is utilized to guide the fastener strip including a plurality of fasteners. The feed member is utilized to push the fastener strip in a first to direction toward the firing channel. The anti-separating mechanism includes a lever pivotally disposed on the fastener magazine. The lever swings between a stop position and a release position. The lever includes a stop surface, a withstanding portion and a tapered pushing surface. The tapered pushing surface is farther from the firing channel than the stop surface.

### BACKGROUND

1. Technical Field

The present disclosure relates to an electric/pneumatic tool (fastener gun) for continuous use of fasteners. More particularly, the present disclosure relates to an anti-separating mechanism of the fastener gun for prevent the fastener strip from separating.

2. Description of Related Art

A conventional fastener gun is disclosed in Taiwan Application Serial Number 98101444 (Taiwan Publication Number 201026450 A1), titled “Method for continuous use of fasteners” (hereafter referred to as “444”). The application discloses that a fastener gun 10 fires fasteners 31 of the fastener strip 30 sequentially. When the fasteners 31 are fired respectively, the feed member 13 may move the fastener strip 30 so that the next fastener 31 enters into the firing channel. A locating element 15 formed as a leaf spring is utilized to position the fastener strip at a predetermined position.

In practice, during the replacement of the fastener strip, a user is used to pull out a new fastener strip slightly for testing the fixing status thereof after the new fastener strip is inserted. However, the direction of pulling is not the default loading direction of the locating element 15, and the pulling action may result in irrecoverable bending or damage of the location element 15. As a result, the location element 15 may be failed to position the fastener strip at the predetermined position.

For the forgoing reason, there is a need for providing a protection mechanism to prevent the fastener strip from pulling in a reverse direction and prevent the locating element from damage.

### SUMMARY

One aspect of this disclosure provides an anti-separating mechanism for preventing a fastener strip from moving reversely and separating from a fastener gun.

In order to implement the aspect above and others, an anti-separating mechanism for preventing a fastener strip from separating from a fastener gun is disclosed. The fastener gun includes a gun body, a fastener magazine and a feed member. The gun body includes a firing channel to receive a fastener. The fastener magazine is connected to the firing channel and is utilized to guide the fastener strip comprising a plurality of fasteners. The feed member is utilized to push the fastener strip in a first direction toward the firing channel. The anti-separating mechanism includes a lever pivotally disposed on the fastener magazine. The lever may swing between a stop position and a release position. The lever has a stop surface, a tapered pushing surface and a withstanding portion. The tapered pushing surface is farther from the firing channel than the stop surface. When the lever is located at the stop position, the withstanding portion withstands the fastener magazine, and the stop surface withstands the fastener strip in the fastener magazine so that it prevents the fastener strip from moving in the second direction far from the firing channel. When the feed member pushes the fastener strip in the first direction, the fasten strip withstands the tapered pushing surface so that the lever swings to the release position.

The detail structure, features, assembly and operation of the anti-separating mechanism are described in the following embodiments.

It is to be understood that both the foregoing general description and the following detailed description are by examples, and are intended to provide further explanation of the disclosure as claimed.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure. In the drawings,

FIG. 1 is a perspective view of a fastener gun according to one embodiment of this disclosure;

FIG. 2 is a partial perspective view of the fastener gun with a safety unit at a non-firing position and a stopping bar at a second position according to one embodiment of this disclosure;

FIG. 3 is a partial exploded view of the fastener gun according to one embodiment of this disclosure;

FIG. 4 is partial side view of the fastener gun with the safety unit at a firing position and a lever at a stop position according to one embodiment of this disclosure;

FIG. 5 is a partial cross-section view of the fastener gun with the stopping bar at the second position according to one embodiment of this disclosure;

FIG. 6 is a partial side view of the fastener gun with the lever at a release position according to one embodiment of this disclosure;

FIG. 7 is a partial side view of the fastener gun with a fastener strip remaining only one fastener according to one embodiment of this disclosure;

FIG. 8 a partial cross-sectional view of the fastener gun with the stopping bar at a first position according to one embodiment of this disclosure; and

FIG. 9 is a partial perspective view of the fastener gun with the safety unit at the non-firing position and the stopping bar at the first position according to one embodiment of this disclosure.

### DESCRIPTION OF THE EMBODIMENTS

Reference will now be made in detail to the present embodiments of the disclosure examples of which are illustrated in the accompanying drawings. Wherever possible, the same reference numbers are used in the drawings and the description to refer to the same or like parts.

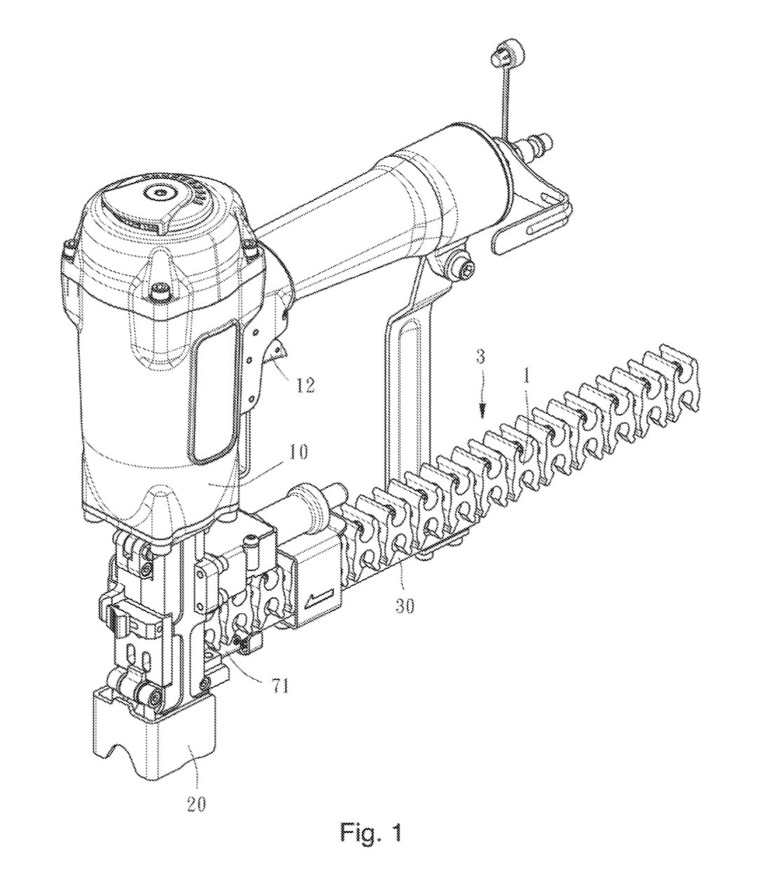

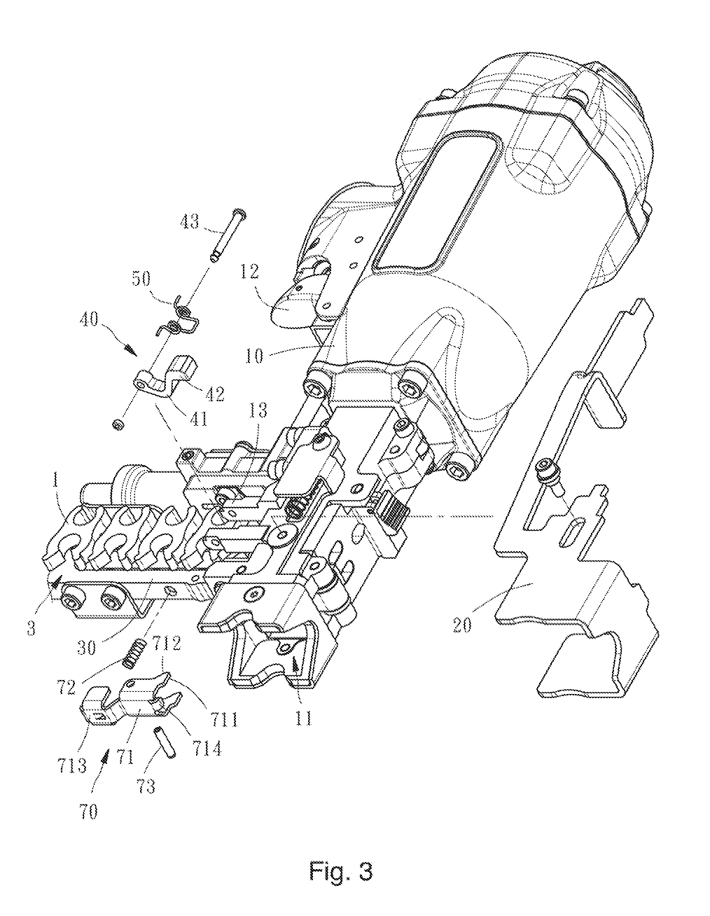

Referring to FIGS. 1 to 4, the fastener gun includes a gun body 10, a safety unit 20, a fastener magazine 30, a stopping bar 40, a first elastic member 50, a feed member 60 and an anti-separating mechanism 70, the anti-separating mechanism 70 is for preventing a fastener strip 3 from separating from the fastener gun.

The gun body 10 has a firing channel 11 to receive a fastener 1 A pivot portion 13 is disposed between the fastener magazine 30 and the firing channel 11. The gun body 10 has a trigger 12. When firing conditions are satisfied, the user pulls the trigger 12, and a rammer (not shown) is actuated by the trigger 12, so that the fastener 1 in the firing channel 11 is fired.

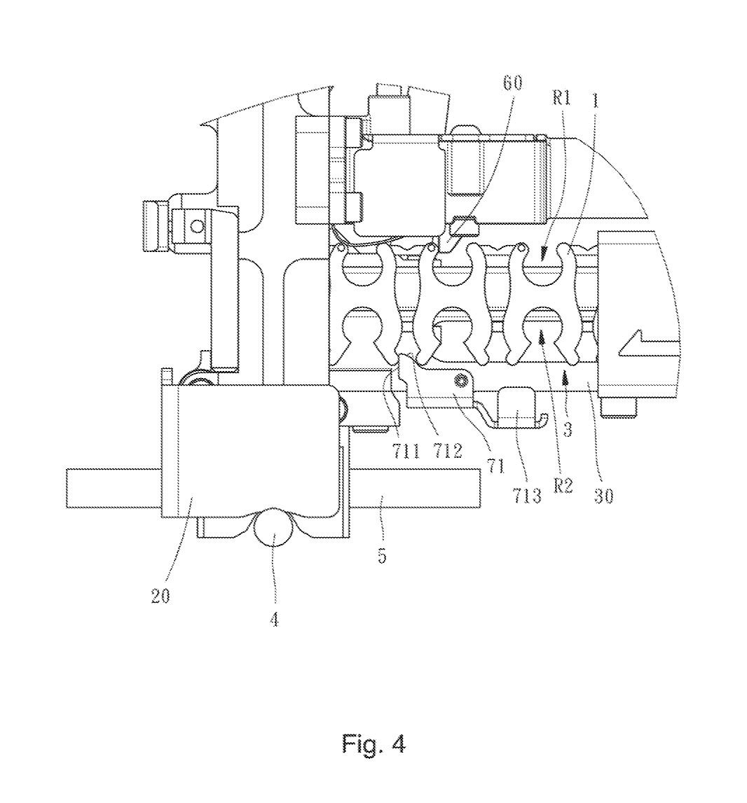

One of the firing conditions is controlled by the safety unit 20. The safety unit 20 is disposed on the firing channel 11 and the safety unit 20 may move between a firing position and a non-firing position. When the safety unit 20 is at the non-firing position (as shown in FIGS. 1, 2, 7, 9) the trigger cannot be pulled. Otherwise, when the trigger is pulled, the rammer may not be actuated. Accordingly, the fastener 1 in the firing channel 11 is ensured not to be fired. When the safety unit 20 is at the firing position (as shown in FIG. 4) and the other firing conditions are satisfied (for example, when the fastener gun is a pneumatic fastener gun, the fastener gun is connected to a high-pressure air source; or when the fastener gun is an electric fastener gun, the fastener gun is connected to a power source), the user may pull the trigger 12 and the rammer s actuated, so that the fastener 1 is fired. The detailed structure and relationship of trigger 12, safety unit 20 and the rammer are not repeated herein because they are not the protection cope of this disclosure but are similar to the prior art.

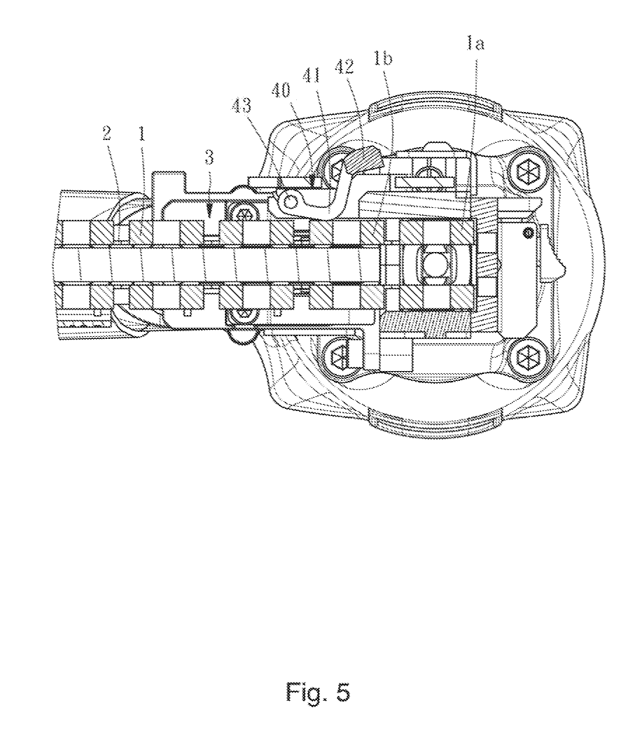

The fastener magazine 30 is connected to the firing channel 11 and is utilized to guide the fastener strip 3. The fastener strips includes the fasteners 1. The fastener strip 3 further includes several connection sections 2 connecting every two of the adjacent fasteners 1, 1a, 1b (as shown in FIG. 5). A first fastener 1a is the fastener of the fastener strip 3 located in the firing channel 11. A second fastener 1b is the fastener adjacent to the first fastener 1a. In this embodiment, the fasteners 1, 1a, 1b are utilized to fasten the two shafts 4, 5 vertically intersected with each other (for example, reinforcing steel bars referring to FIG. 4). Each of the fasteners 1 includes an upper opening R1 and a lower opening R2. The other structures of the fastener strip 3 and the fasteners 1, 1a, 1b are not the subject matters of this disclosure and are conventional arts. For example, a possible embodiment of a fastener strip and a fastener is disclosed in the Taiwan Application Aerial Number 98101444. Therefore, the structures are not repeated herein.

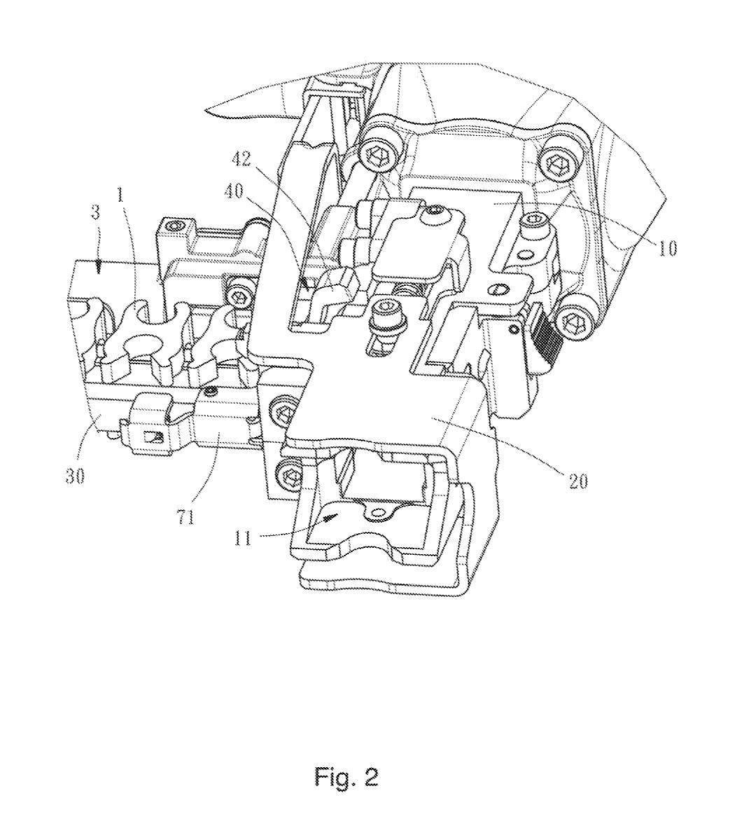

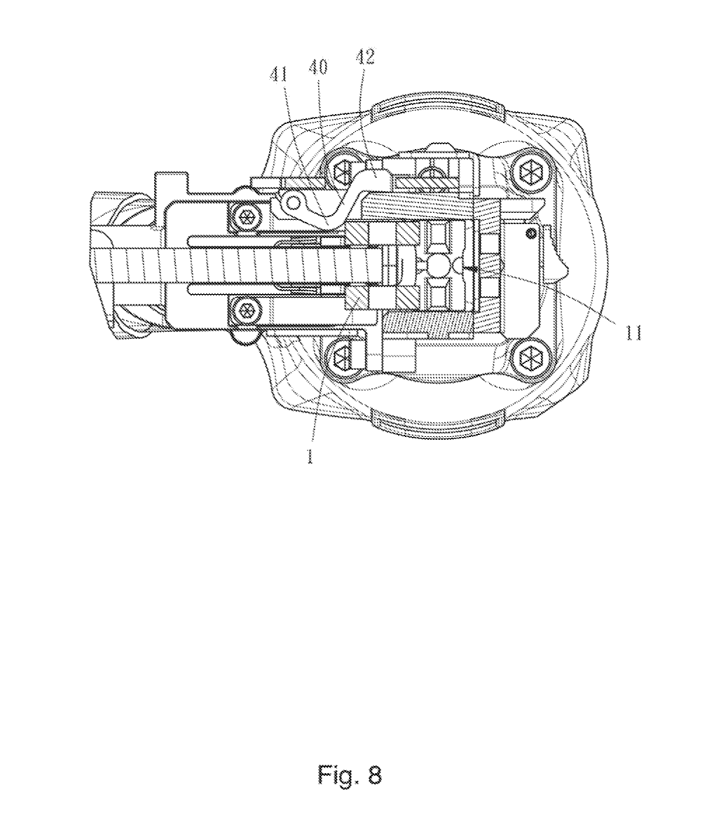

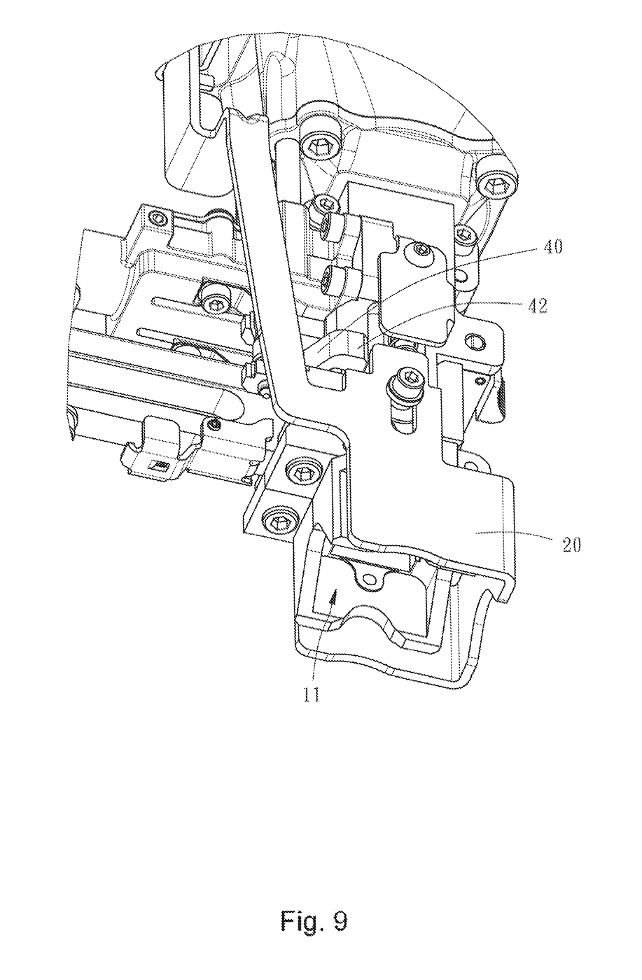

By a pivot 43, the stopping bar 40 is pivotally disposed on the pivot portion 13 of the gun body 10, so that the stopping bar 40 may swing between a first position (as shown in FIGS. 8, 9) and a second position (as shown in FIGS. 2, 5). The stopping bar 40 has a pushing portion 41 and a stop portion 42. The pushing portion 41 may be optionally pushed by the fastener strip 3 in the fastener magazine 30. The stop portion 42 may stop the movement of the safety unit 20.

The first elastic member 50 is utilized to provide the stopping bar 40 with the elastic force in order to move back the stopping bar 40 to the first position. For example, the first elastic member 50 is a torsion spring respectively abutted with the stopping bar 40 and the pivot portion 13. However, the first elastic member 50 may be replaced by other spring, rubber and the like in different type.

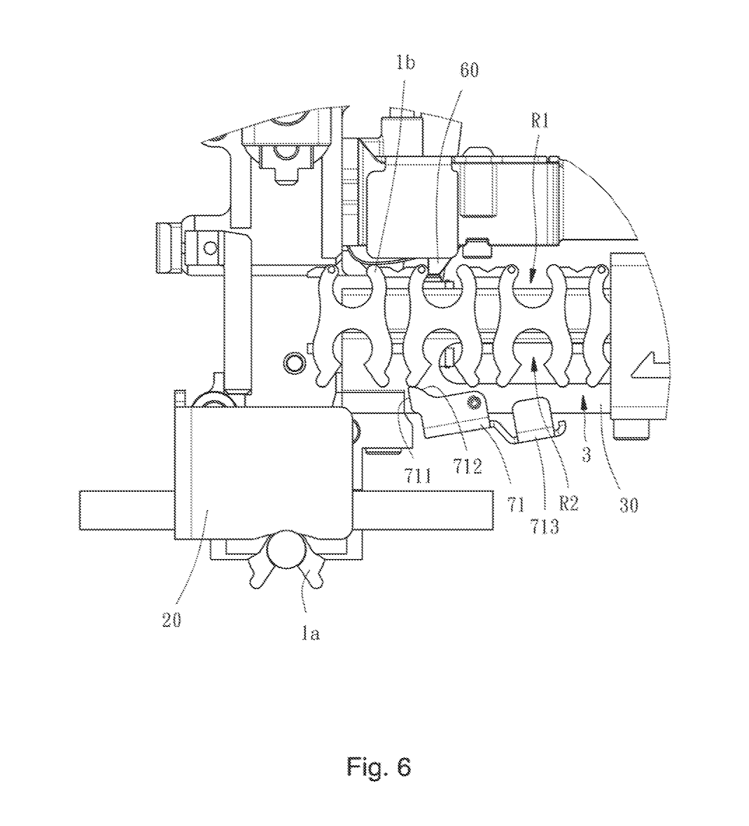

The feed member 60 is utilized to push the fastener strip 3 in a first direction toward the firing channel 11. For example, after the first fastener 1a is fired, the feed member 60 pushes the fastener strip 3 so that the second fastener 1b enters into the firing channel 11 (as shown in FIG. 6). The feed member 60 is disposed on the top of the fastener magazine 30. In details, the feed member 60 pushes the upper opening R1 of the fastener 1, so that the fastener strip 3 is moved in the first direction toward the firing channel 11. The feed member 60 may be interlocked with the trigger 12 or the rammer. The feed member 60 may be pneumatic and controlled by the trigger 12. The detailed structure of the feed member 60 is not the subject matter of this disclosure and is in the field of conventional art. Thus, it is not repeated herein.

The anti-separating mechanism 70 includes a lever 71 and a second elastic member 72. By a pivot 73, the lever 71 is pivotally disposed on the fastener magazine 30, so that the lever 71 may swing between a stop position (as shown in FIG. 4) and a release position (as shown in FIG. 6). The lever 71 has a stop surface 711, a tapered pushing surface 712 and a pushing arm 713. The tapered pushing surface 712 is farther from the firing channel 11 than the stop surface 711. When the lever 71 is located at the stop position, the stop surface 711 is vertical to the first direction Furthermore, the lever 71 further includes a withstanding portion 714, When the lever 71 is located at the stop position, the withstanding portion 714 withstands the fastener magazine 30, so that the lever 71 cannot swing close to the fastener magazine 30. In more detail, the anti-separating mechanism 70 is disposed below the fastener magazine 30. When the lever 71 of the anti-separating mechanism 70 is located at the stop position, the stop surface 711 and the tapered pushing surface 712 are located between two of the adjacent lower openings R2 of the fasteners 1. When the lever 71 of the anti-separating mechanism 70 is located at the release position, the stop surface 711 and the tapered pushing surface 712 move outside the moving path of the fastener strip 3. The second elastic member 72 is utilized to provide the lever 71 with the elastic force in order to move back the lever 71 to the stop position. In this embodiment, the second elastic member 72 may be a coil spring and disposed between the pushing arm 713 and the fastener magazine 30. However, the type and the configuration of the second elastic member 72 are not limit to those disclosed in this embodiment.

The operation of the fastener gun according to this embodiment is explained below through the accompanying drawings.

As shown in FIGS. 2 and 4, when the feed member 60 pushes the fastener strip 3 in the first direction until the first fastener 1a enters into the firing channel 11, the lever 71 is located at the stop position. Then, the stop surface 711 withstands the fastener strip 3, so that it prevents the fastener strip 3 from moving in the second direction far from the firing channel 11.

As shown in FIGS. 4 and 5, the pushing portion 41 of the stopping bar 40 is pushed by the second fastener 1b of the fastener strip 3, so that the stopping bar 40 is located at the second position. Accordingly, the stop portion 42 of the stopping bar 40 may not stop the movement of the safety unit 20. The user may place the firing channel 11 on the shafts 4 and 5, and moves the safety unit 20 from the non-firing position to the firing position. The fastener gun may fire the first fastener 1a whenever the trigger 12 is pulled.

As shown in FIG. 6, after the user pulls the trigger 12 and the rammer is actuated to fire the fastener 1a. the feed member 60 pushes the fastener strip 3 in the first direction. Simultaneously, the fastener strip 3 pushes the tapered pushing surface 712, so that the lever 71 swings to the release position and the feeding movement of the fastener strip 3 is not stopped. After the feeding operation of the fastener strip 3 is completed, the status of the fastener gun is recovered as shown in FIG. 2.

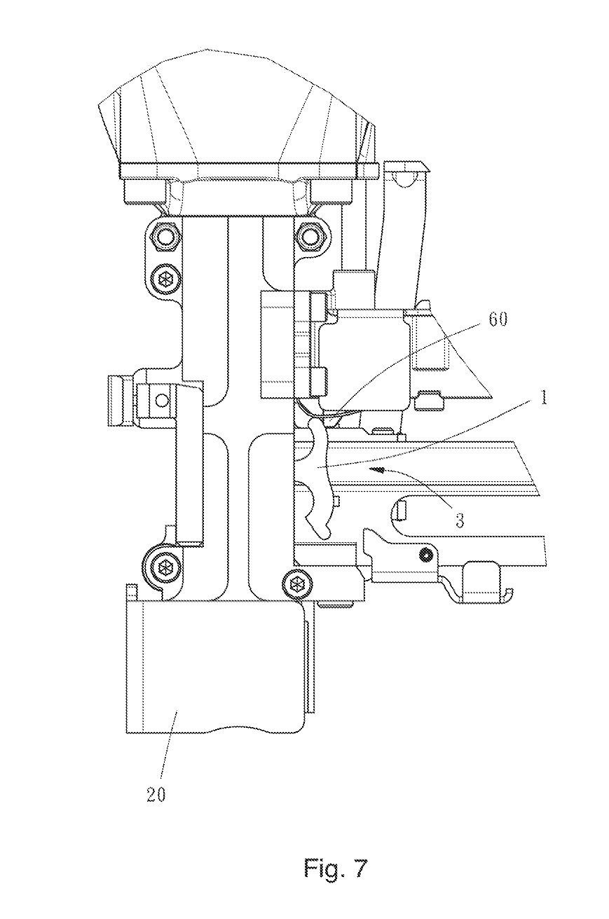

As shown in FIGS. 7 to 9, when the fastener gun fires the fasteners repeatedly till the fastener strip 3 remains only one fastener 1, the movement of the feed member 60 can not push the fastener 1 into the firing channel 11 thoroughly. At this moment, if the rammer is actuated to hit the fastener 1, the fastener 1 may not be fired successfully so as to damage the fastener gun. Therefore, in the embodiment, the stopping bar 40 may get back to the first position, that is, the pushing portion 41 may not be pushed by the fastener strip 3. Then, the stop portion 42 may stop the movement of the safety unit 20, so that the safety unit 20 is kept at the non-firing position. Accordingly, the hitting action of the rammer is avoided in other words, before the fastener strip is replaced by a new one, the fastener gun may not fire anymore.

According to the aforementioned description of the present disclosure, when the remaining fastener of the fastener strip is insufficient (remaining only one fastener in the embodiment above), the improper firing is avoided. However, the sufficient remaining quantity of the fastener may be changed by adjusting the disposing position of the stopping bar. Furthermore, the anti-separating mechanism may prevent the fastener gun from damaged by improperly pulling the fastener strip. Thus, the maintenance cost of the fastener gun is saved.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. An anti-separating mechanism for preventing a fastener strip from separating from a fastener gun disposed in the fastener gun, wherein the fastener gun comprises a gun body, a fastener magazine and a feed member, the gun body comprises a firing channel to receive a fastener, the fastener magazine is connected to the firing channel and is utilized to guide the fastener strip comprising a plurality of fasteners, and the feed member is utilized to push the fastener strip in a first direction toward the firing channel, the anti-separating to mechanism comprising:
a lever pivotally disposed on the fastener magazine, wherein the lever swings between a stop position and a release position, the lever comprises a stop surface, a tapered pushing surface and a withstanding portion, and the tapered pushing surface is farther from the firing channel than the stop surface;
wherein when the lever is located at the stop position, the withstanding portion withstands the fastener magazine, and the stop surface withstands the fastener strip in the fastener magazine so that it prevents the fastener strip from moving in a second direction far from the firing channel; and
wherein when the feed member pushes the fastener strip in the first direction, the fasten strip withstands the tapered pushing surface so that the lever swings to the release position.

2. The anti-separating mechanism of claim 1, further comprising:
an elastic member for providing the lever with an elastic force to move the lever back to the stop position.

3. The anti-separating mechanism of claim 2, wherein the lever further comprises a pushing arm, and the elastic member is disposed between the pushing arm and the fastener magazine.

4. The anti-separating mechanism of claim wherein when the lever is located at the stop position, the stop surface is vertical to the first direction.

5. The anti-separating mechanism of claim 2, wherein when the lever is located at the stop position, the stop surface is vertical to the first direction.

6. The anti-separating mechanism of claim 3, wherein when the lever is located at the stop position, the stop surface is vertical to the first direction.

7. The anti-separating mechanism of claim 1, wherein the feed member is disposed on the top of the fastener magazine, each of the fasteners has an upper opening, and the feed member pushes one of the upper openings of the fasteners in the first direction toward the firing channel.

8. The anti-separating mechanism of claim 1, wherein the anti-separating mechanism is disposed below the fastener magazine, each of the fasteners has a lower opening, and when the anti-separating mechanism is located at the stop position, the stop surface and the tapered pushing surface of the lever are located between two of the adjacent lower openings.

9. The anti-separating mechanism of claim 8, wherein when the anti-separating mechanism is located at the release position, the stop surface and the tapered pushing surface of the lever move outside the moving path of the fastener strip.
